(19) United States
(12) Patent Application Publication
(10) Pub. No.: US 2008/0160370 A1
(43) Pub. Date: Jul. 3, 2008

(54) Adaptive Current Controller for a Fuel-Cell System

(75) Inventors: Stephane Masse, Toronto (CA); Ravi B. Gopal, Toronto (CA)

Correspondence Address: BERESKIN AND PARR, 40 KING STREET WEST, BOX 401, TORONTO, ON, M5H 3Y2, omitted

(73) Assignee: Hydrogenics Corporation, Mississauga, Ontario (CA)

(21) Appl. No.: 11/570,170

(22) PCT Filed: Jul. 12, 2005
(86) PCT No.: PCT/CA2005/001072

§ 371 Date: Dec. 7, 2006

Related U.S. Application Data
(60) Provisional application No. 60/586,709, filed on Jul. 12, 2004.

(51) Int. Cl. H01M 8/04

(52) U.S. Cl. 429/23

(57) ABSTRACT

Fuel cell modules usually have an inherently limited load slew rate, which is adequate for some applications but insufficient where close load following is desired. An example of where the inherent lack of dynamic response, of a typical fuel cell module, has proven to be insufficient is within a standalone AC power generation system in which the fuel cell module does not, or cannot, possibly, receive a priori knowledge of current demand changes by load. In contrast, the present invention aims to provide a current controller for use in a fuel cell system, a fuel cell system with adaptive current control and a method of operating a fuel cell system that employs an adaptive current controller that enables a relatively fast dynamic response to abrupt increases in current demand whilst also providing a controlled adjustment to the output current provided by a fuel cell module included in the system. The adaptive current control system includes a fuel cell module, an ultra-capacitor, a current limiter, and a processor with several inputs and at least one output for detecting and controlling current conditions in the fuel cell system.

### FIELD OF THE INVENTION

The invention relates to fuel cells and, in particular to apparatus, systems and methods for controlling the current draw from a fuel cell module.

### BACKGROUND OF THE INVENTION

A fuel cell is a type of electrochemical device that produces electrical energy from the stored chemical energy of reactants according to a particular electrochemical process. One example of a particular type of fuel cell is a Proton Exchange Membrane (PEM) fuel cell that is operable to provide electrical energy to a load. Generally, a PEM fuel cell includes an anode, a cathode and thin polymer membrane arranged between the anode and cathode. Hydrogen and an oxidant are supplied as reactants for a set of complementary electrochemical reactions that yield electricity, heat and water.

The oxidant for a fuel cell can be provided by oxygen carrying ambient air. In high-pressure fuel cell systems ambient air is forced through an air compressor to increase the rate and pressure at which oxygen is delivered to the cathodes in the fuel cell stack. However, air compressors typically require a relatively large energy input to be operable. Providing this relatively large amount energy to an air compressor reduces the overall efficiency of a fuel cell module operating as a power plant.

Low-pressure fuel cell systems have been developed that have relaxed input pressure requirements with respect to the oxidant input stream. As a result, air compressors can be replaced with lower energy air blowers, which improve the overall efficiency of a fuel cell module. However, a problem common to many low-pressure fuel cell systems is that such systems typically have a slow output transient response to abrupt and/or fast load variations. For example, in a fuel cell powered vehicle rapid acceleration causes an abrupt increase in the output current drawn from a fuel cell module. This increase in output current is temporary and cannot be sustained, as it is the result of a temporary increase in the electrochemical reaction rates within the fuel cell module that rapidly deplete the available reactants from within the fuel cell module. If the reactants are not replenished at a fast enough rate the fuel cell module may stall, which may in turn damage the fuel cell module. Moreover, the transient increase in output current may be a current spike that may damage the fuel cell module. A prior known partial solution includes employing stronger air blowers capable of forcing more ambient air into the fuel cell module to reduce instances of stalling by providing more oxygen to fuel the electrochemical reactions as required. However, this solution does not effectively address the lag time between an abrupt increase in output current demand and the amount of time required to increase the electrochemical reaction rates that produce more output current. Additionally, the stronger air blowers require more energy, which in turn reduces the efficiency.

### SUMMARY OF THE INVENTION

According to an aspect of an embodiment of the invention there is provided an adaptive current controller, for use in a fuel cell system including a fuel cell module and an ultra-capacitor, comprising: a first electrical node connectable to the ultra-capacitor; a current limiter, connectable between the fuel cell module and the first electrical node, for adjustably limiting the output current of the fuel cell module to an upper-limit current level; and a processor, connectable to the fuel cell module and the current limiter, having a first input to receive a measurement of the output current of the fuel cell module, a second input to receive a measurement of a current demand, a first output to provide the fuel cell module with a first control signal for changing an operating level of the fuel cell module, and logic for generating the first control signal as a function of the measurements of the output current and current demand.

In some embodiments, the processor additionally comprises a second output to provide the current limiter a second control signal for changing the upper-limit current level and additional logic for generating the second control signal as a function of the operating level.

In some embodiments, the logic includes a computer readable program code means embodied thereon for (i) determining if at least one of the output current and the current demand have increased; and (ii) signaling the fuel cell module to change the operating level by increasing reactant flow through the use of the first control signal. In some more specific embodiments the computer readable program code means also includes instructions for (iii) signaling the current limiter to increase the upper-limit current level through the use of the second control signal. In some even more specific embodiments the upper-limit current level is signaled to increase if the present upper-limit current level is less than the current demand. In other even more specific embodiments, the upper-limit current level is signaled to increase as an automatic response to any increase signaled through use of the first control signal.

In some embodiments, the fuel cell module is a low-pressure fuel cell module employing an air blower to supply oxygen carrying ambient air to the fuel cell module, and wherein the first control signal is employed to change the operation of the air blower to thereby change the amount of oxygen carrying air supplied to the fuel cell module which changes the operating level of the fuel cell module.

In some embodiments, the current limiter includes an active electronic device connectable to the processor for receiving a second control signal for changing the upper-limit current level enforced by the current limiter. In some more specific embodiments, the active electronic device is a transistor. In other more specific embodiments, the current limiter includes a switching mechanism in parallel with the active electronic device for selectively shorting the fuel cell module to the first electrical node, thereby allowing the output current of the fuel cell module to bypass the active electronic device. In some even more specific embodiments the switching mechanism is connectable to the processor for receiving a third control signal for selectively shorting the electrical output of the fuel cell module to the first electrical node.

In some embodiments, the current limiter includes a series combination of a resistor and a diode connected between the fuel cell module and the first electrical node. In some more specific embodiments, the current limiter includes a switching mechanism in parallel with the series combination of the resistor and a diode for selectively shorting the fuel cell module to the first electrical node, thereby allowing the output current of the fuel cell module to bypass the series combination of the resistor and the diode. In some even more specific embodiments, the switching mechanism is connectable to the processor for receiving a third control signal for selectively shorting the electrical output of the fuel cell module to the first electrical node.

According to an aspect of an embodiment of the invention there is provided a fuel cell system comprising: a fuel cell module; an ultra-capacitor pack having at least one ultra-capacitor; and an adaptive current controller having: a first electrical node connectable to the ultra-capacitor, a current limiter, coupled between the fuel cell module and the first electrical node, for adjustably limiting the output current of the fuel cell module to an upper-limit current level; and a processor, coupled to the fuel cell module and the current limiter, having a first input to receive a measurement of the output current of the fuel cell module, a second input to receive a measurement of a current demand, a first output to provide the fuel cell module with a first control signal for changing an operating level of the fuel cell module, and logic for generating the first control signal as a function of the measurements of the output current and current demand.

According to an aspect of an embodiment of the invention there is provided a method of operating a fuel cell system, the fuel cell system including a fuel cell module and an ultra-capacitor, the method comprising: measuring the output current of the fuel cell module and current demand; determining if at least one of the output current and current demand have changed; signaling the fuel cell module to change the reactant flow in response to a change in either of the output current and current demand.

In some embodiments, the method further comprises the steps of: determining if the current demand is greater than an upper-limit current level enforced on the fuel cell module; and increasing the upper-limit current level if the current demand is greater than the upper-limit current level. In some embodiments, if at least one of the output current and current demand have increased, the fuel cell module is signaled to increase reactant flow. In some embodiments, if both the output current and current demand have decreased, the fuel cell module is signaled to decrease reactant flow.

According to an aspect of an embodiment of the invention there is provided a method of operating a fuel cell system, the fuel cell system including a fuel cell module and an ultra-capacitor, the method comprising: monitoring at least one of the voltage and charge on the ultra-capacitor; determining if the monitored at least one of the voltage and charge is below a first lower limit; one of turning-on and increasing the output current of the fuel cell module if the monitored at least one of the voltage and charge is below the first lower limit; monitoring the output current of the fuel cell module; determining if the output current is below a second lower limit; and turning-off the fuel cell module if the output current is below the second lower limit.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a simplified schematic drawing of a fuel cell module;

FIG. 2 is a schematic drawing of a first fuel cell system having adaptive current control according to an embodiment of the invention;

FIG. 3 is a schematic drawing of a second fuel cell system having adaptive current control according to an embodiment of the invention;

FIG. 4 is a schematic drawing of a third fuel bell system having adaptive current control according to an embodiment of the invention;

FIG. 5 is a schematic drawing of a fourth fuel cell system having adaptive current control according to an embodiment of the invention;

FIG. 6 is a graphical illustration of an example transient current response of a fuel cell system, according to an aspect of the invention, to an abrupt change in output current demand from a load;

FIG. 7 is a graphical illustration of an example of efficiency vs. output current for a fuel cell system according to an aspect of the invention;

FIG. 8 is a flow chart illustrating a first method of adaptive current control according to an aspect of the invention; and

FIG. 9 is a flow chart illustrating a second method of adaptive current control according to an aspect of the invention.

### DETAILED DESCRIPTION OF THE INVENTION

A fuel cell stack is typically made up of a number of singular fuel cells connected in series. The fuel cell stack is included in a fuel cell module that includes a suitable combination of supporting elements, collectively termed a balance-of-plant system, which is specifically configured to maintain operating parameters and functions for the fuel cell stack in steady state operation. Example functions of a balance-of-plant system include the maintenance and regulation of various pressures, temperatures and flow rates. Accordingly those skilled in the art will understand that a fuel cell module also includes a suitable combination of associated structural elements, mechanical systems, hardware, firmware and software that is employed to support the function and operation of the fuel cell module. Such items include, without limitation, piping, sensors, regulators, current collectors, seals, insulators and electromechanical controllers. Hereinafter only those items relating to aspects specific to the present invention will be described.

There are a number of different fuel cell technologies and, in general, this invention is expected to be applicable to all types of fuel cells. Very specific example embodiments of the invention have been developed for use with Proton Exchange Membrane (PEM) fuel cells. Other types of fuel cells include, without limitation, Alkaline Fuel Cells (AFC), Direct Methanol Fuel Cells (DMFC), Molten Carbonate Fuel Cells (MCFC), Phosphoric Acid Fuel Cells (PAFC), Solid Oxide Fuel Cells (SOFC) and Regenerative Fuel Cells (RFC).

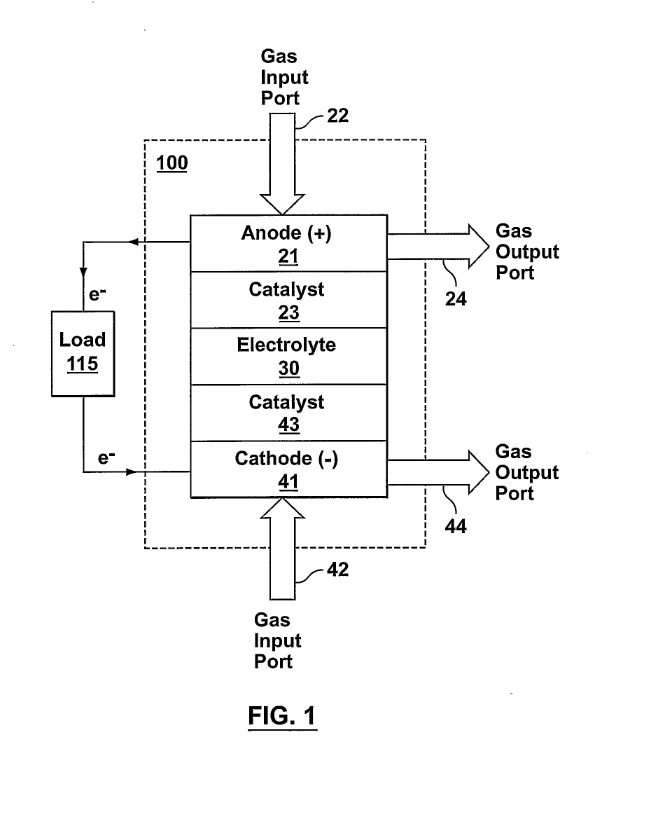

Referring to FIG. 1, shown is a simplified schematic diagram of a Proton Exchange Membrane (PEM) fuel cell module, simply referred to as fuel cell module 100 hereinafter, that is described herein to illustrate some general considerations relating to the operation of electrochemical cell modules. It is to be understood that the present invention is applicable to various configurations of fuel cell modules that include one or more fuel cells.

The fuel cell module 100 includes an anode electrode 21 and a cathode electrode 41. The anode electrode 21 includes a gas input port 22 and a gas output port 24. Similarly, the cathode electrode 41 includes a gas input port 42 and a gas output port 44. An electrolyte membrane 30 is arranged between the anode electrode 21 and the cathode electrode 41.

The fuel cell module 100 also includes a first catalyst layer 23 between the anode electrode 21 and the electrolyte membrane 30, and a second catalyst layer 43 between the cathode electrode 41 and the electrolyte membrane 30. In some embodiments the first and second catalyst layers 23, 43 are directly deposited on the anode and cathode electrodes 21, 41, respectively.

A load 115 is connectable between the anode electrode 21 and the cathode electrode 41.

In operation, hydrogen fuel is introduced into the anode electrode 21 via the gas input port 22 under some predetermined conditions. Examples of the predetermined conditions include, without limitation, factors such as flow rate, temperature, pressure, relative humidity and a mixture of the hydrogen with other gases. The hydrogen reacts electrochemically according to reaction (1), given below, in the presence of the electrolyte membrane 30 and the first catalyst layer 23.

H₂ [symbol] H⁺+2e⁻ (1)

The chemical products of reaction (1) are hydrogen ions (i.e. cations) and electrons. The hydrogen ions pass through the electrolyte membrane 30 to the cathode electrode 41 while the electrons are drawn through the load 115. Excess hydrogen (sometimes in combination with other gases and/or fluids) is drawn out through the gas output port 24.

Simultaneously an oxidant, such as oxygen in the ambient air, is introduced into the cathode electrode 41 via the gas input port 42 under some predetermined conditions. Examples of the predetermined conditions include, without limitation, factors such as flow rate, temperature, pressure, relative humidity and a mixture of the oxidant with other gases. The excess gases, including the excess oxidant and the generated water are drawn out of the cathode electrode 41 through the gas output port 44. As noted above, in low-pressure fuel cell systems (modules) the oxygen is supplied via oxygen carrying ambient air that is urged into the fuel cell stack using air blowers (not shown).

The oxidant reacts electrochemically according to reaction (2), given below, in the presence of the electrolyte membrane 30 and the second catalyst layer 43.

½O₂+2H⁺+2e⁻ [symbol] H₂O (2)

The chemical product of reaction (2) is water. The electrons and the ionized hydrogen atoms, produced by reaction (1) in the anode electrode 21, are electrochemically consumed in reaction (2) in the cathode electrode 41. The electrochemical reactions (1) and (2) are complementary to one another and show that for each oxygen molecule (O₂) that is electrochemically consumed two hydrogen molecules (H₂) are electrochemically consumed.

The rate and pressure at which the reactants, hydrogen and oxygen, are delivered into the fuel cell module 100 effects the rate at which the reactions (1) and (2) occur. The reaction rates are also affected by the current demand of the load 115. As the current demand of the load 115 increases the reactions rate for reactions (1) and (2) increases in an attempt to meet the current demand.

Increased reaction rates cannot be sustained unless the reactants are replenished at a rate that supports the consumption requirements of the fuel cell module 100. As noted above, fuel cell power generators (i.e. a fuel cell module employed to supply power to a load, as shown in FIG. 1) exhibit good steady-state performance but may perform less well in terms of dynamic response to abrupt changes in current demand from a load.

That is, fuel cells usually have an inherently limited load slew rate, which is adequate for some applications, but insufficient where close load following is desired. An example of where the inherent lack of dynamic response, of a typical fuel cell module, has proven to be insufficient is within a standalone AC power generation system in which the fuel cell module does not, or cannot possibly, receive a priori knowledge of current demand changes by the load.

In contrast, some embodiments of the present invention provide a fuel cell system with adaptive current control enabling a relatively fast dynamic response to abrupt increases in current demand whilst also providing a controlled adjustment to an operating level a fuel cell module included in the system (e.g. controlled adjustment of reactant flow(s) corresponding to a desired output current).

In an attempt to provide a fuel cell system with a faster dynamic response, a fuel cell module may be coupled with another power source exhibiting better transient behavior. Typically, batteries have been used to achieve this, but batteries have inherent drawbacks that include, for example, weight, limited durability and toxic chemicals. The use of batteries, in combination with a fuel cell module, is often not suitable for applications where the desired output of a fuel cell system would require a large number of batteries. Moreover, batteries are commonly designed to deliver a relatively low average power over a relatively long lifetime. In contrast, using batteries to provide transient responses to abrupt increases in current (or power) demand (meaning the batteries must provide short bursts of large current), often leads to accelerated degradation and a reduced lifetime of the batteries.

A better option is the use of ultra-capacitors instead of batteries. An ultra-capacitor is suitable for storing and rapidly releasing a current burst with high power density. In particular, in accordance with some embodiments of the present invention high-current and high-capacity ultra-capacitors can advantageously be combined with PEM fuel cell modules to provide a fuel cell system having a relatively fast dynamic response. However, while ultra-capacitors are suitable for delivering short current bursts, even high-capacity ultra-capacitors generally lack the storage capacity to provide current over extended transient peak loads.

Another device may be employed to deliver the elevated levels of output current from the fuel cell system during and/or after the stored capacity of the ultra-capacitor(s) diminishes. According to some embodiments of the present invention the fuel cell module is employed to deliver the elevated levels of output current that may continue to be required of the fuel cell system after an abrupt increase in current demand from the load. The fuel cell module is controlled by an adaptive current control function that manages the transient response of the fuel cell system as a whole. The adaptive current control function may be integrated into a balance-of-plant system included in the fuel cell module or it may be provided in a separate controller connectable to the fuel cell module.

A benefit of combining an ultra-capacitor pack with a fuel cell module is that the fuel cell module does not have to be designed to meet power requirements of a particular load when the peak power (or current) demands only lasts a short time. That is, if the peak power requirements occur in limited demand bursts, instead of sizing a fuel cell stack (within the module) for peak power, the fuel cell stack can be sized to provide a much smaller average power if the fuel cell module is coupled with an ultra-capacitor pack to provide output current bursts.

The following is a description of a non-limiting example provided to better illustrate benefit described in the previous paragraph. An application where a 20 kW peak load requirement is coupled to an average power draw of 2.5 kW. The ratio between the peak and average power draw is around 8:1. Such an application can be addressed with a small fuel cell provided in combination with an ultra-capacitor pack. If only fuel cell stack was employed the fuel cell stack would have to provide the peak power of 20 kW, when it was required. On the other hand, using a fuel cell stack in combination with an ultra-capacitor pack may enable the use of a fuel cell stack sized to provide only 5 kW of peak power. The ultra-capacitor pack would be sized to be able to deliver the required extra power over the short bursts as required. It should be noted here that both systems (i.e. the fuel cell module alone and the fuel cell module in combination with the ultra-capacitor pack) have the same average total power output of 2.5 kW.

As fuel cell technology is still quite expensive (even versus ultra-capacitors), the combination of fuel cells and ultra-capacitors may lower the overall cost of a fuel cell-based generator. Additionally, some ultra-capacitors are made with non-toxic materials, which makes them better suited than batteries, including toxic and/or hazardous materials, for use in environments where the potential for toxic spills and/or gas leaks must be reduced.

Many commercially available ultra-capacitors have limited voltage characteristics (e.g. around 2.5V). Subsequently, a number of ultra-capacitors need to be connected in series in order to accommodate higher voltages. A series organization of a number of ultra-capacitors is referred to as a string. For example, to accommodate a working voltage of 60V, twenty-four 2.5V ultra-capacitors organized in series can be used. Often special circuitry is required to ensure that the total voltage is evenly distributed across an ultra-capacitor string that is often provided by the manufacturers of ultra-capacitors. Additionally, if a higher capacitance is required for a given application, ultra-capacitors and/or ultra-capacitor strings can be placed electrically in parallel. Placing ultra-capacitors and/or ultra-capacitor strings in parallel within an ultra-capacitor pack, often has the additional benefit of reducing the equivalent series resistance of the ultra-capacitor pack, which in turn improves output current (and thus power) delivery capability.

Another benefit of combining an ultra-capacitor pack with a fuel cell module is that the combination can then be further combined in vehicles employing a regenerative braking system. Since fuel cell systems are usually not designed to store power from an application, another device must be used to store the energy captured during regenerative braking and/or an equivalent process. Ultra-capacitors work well in both charging and discharging modes of operation, which allows them to capture power better than batteries for the same reasons described above.

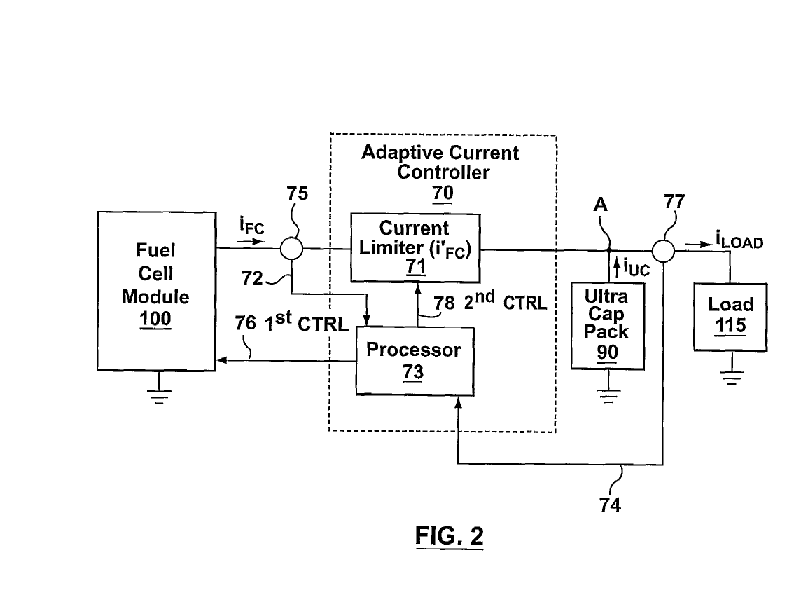

Referring to FIG. 2, shown is a schematic drawing of a first fuel cell system having adaptive current control according to an embodiment of the invention. The first fuel cell system includes the fuel cell module 100 and load 115 from FIG. 1. The first fuel cell system also includes an adaptive current controller 70 and an ultra-capacitor pack 90 housing at least one ultra-capacitor (not shown). The adaptive current controller is connected electrically in series between the fuel cell module 100 and load 115. The ultra-capacitor pack 90 is connected in parallel with the load 115. More specifically, a first electrical node, indicated by A in FIG. 2, is provided to which the ultra-capacitor pack 90 and the load 115 are connected in parallel with one another. A current output of the fuel cell module 100 is also connected to the first electrical node A by way of the adaptive current controller 70.

Briefly, during operation, the load current i_{LOAD} is the aggregate combination of the output current i_{FC} of the fuel cell module 100 and the output current i_{UC} of the ultra-capacitor pack 90. The symbol i_{LOAD} is also used to represent the current demand of the load 115, since it is the load 115 that draws current from the combination of the fuel cell module 100 and the ultra-capacitor pack 90 and it is the load 115 to which the first fuel cell system responds. The adaptive current controller 70 serves to limit the (actual) output current i_{FC} from the fuel cell module 100 drawn by the load 115 to a upper-limit current level i′_{FC} and enables the fuel cell module 100 to controllably increase the output current i_{FC} to meet the current demand i_{LOAD} as required. This is especially useful for managing the transient response after the current demand i_{LOAD} abruptly increases. During such times, the ultra capacitor pack 90 supplies the load 115 with an additional amount of current i_{UC} in addition the limited current i′_{FC} as described above.

Although the output current i_{FC} of the fuel cell is limited, to an upper level of i′_{FC}, it is not necessarily at or near the upper level i′_{FC} during steady state operation. In fact, the output current i_{FC} of the fuel cell module 100 may be below, and be permitted to vary in a range below, the upper level i′_{FC} during steady state operation and/or slow transient current demand i_{LOAD} changes, in which case the load current i_{LOAD} includes the actual output current i_{FC} and the output current i_{UC} from the ultra-capacitor.

In many scenarios the output current i_{UC} from the ultra-capacitor is zero in steady state operation. During slow or fast transient changes in the current demand i_{LOAD} the output current from the ultra-capacitor may be a non-zero value and positive (i.e. flowing towards the load 115). The ultra-capacitor pack 90 may need to replenish the charge stored on its constituent ultra-capacitors after slow or fast transient changes in the current demand i_{LOAD}, in which case the output current from the ultra-capacitor pack 90 may also be a non-zero negative value (i.e. flowing towards the ultra-capacitor pack 90). The current flowing to the ultra-capacitor pack 90 is provided from the fuel cell module 100, which is limited via the adaptive current controller 70. The charging process for the ultra-capacitor is also described in further detail below.

With continued reference to FIG. 2, the adaptive current controller 70 includes a current limiter 71, first and second current sensing devices 75 and 77, and a processor 72.

The current limiter 71 is coupled in series between the current output of the fuel cell module and the first electrical node A, thereby providing a means for limiting the output current i_{FC} of the fuel cell module 100 to the upper-limit current level i′_{FC}. In various alternative embodiments the adaptive current controller 70 may be configured as a buck converter (similar to a high-to-low voltage DC-DC converter, a boost converter and/or a combination thereof providing a dual function (buck-boost) converter. Moreover, those skilled in the art would readily appreciate that the current limiter 71 can be placed on a positive or negative output rail/connection.

The first current sensing device 75 is coupled between the current output of the fuel cell module 100 and the current limiter 71 to sense/measure the actual output current i_{FC} of the fuel cell module 100. The first current sensing device 75 is also coupled to the processor 73 to provide a sensed/measured value of the actual output current i_{FC} to the processor 73. Similarly, the second current sensing device 77 is coupled between the first electrical node A and load 115 to sense/measure the load current i_{LOAD} (i.e. the current flowing to the load 115). The second current sensing device 77 is also coupled to the processor 73 to provide a sensed/measured value of the actual load current i_{LOAD} to the processor 73.

The processor 73 is provided with two inputs and two outputs. The two inputs include a first input for receiving a sensed/measure value of actual output current i_{FC} from the fuel cell module and a second input for receiving a sensed/measure value of the load current i_{LOAD}. The two outputs include a first control signal 76 and a second control signal 78 directed to the fuel cell module 100 and current limiter 71, respectively. The processor 73 also includes logic for adaptively limiting and controlling the output current i_{FC} of the fuel cell module, especially during transient periods after abrupt increases in the current demand i_{LOAD} from the load 115.

As described briefly above in operation the output current i_{FC} of the fuel cell module 100 is initially limited immediately following an abrupt increase in the current demand i_{LOAD} from the load 115, during which time the ultra-capacitor pack 90 automatically meets the initial transient demand by supplying i_{UC}. Simultaneously, the adaptive current controller 70 enables the fuel cell module 100 to controllably increase the fuel cell module 100 output current i_{FC} during the duration where the current burst demanded by the load 115 is initially met by ultra-capacitor pack 90.

The current sensing devices 75 and 77 sense/measure the output current i_{FC} and the current demand i_{LOAD}, and provide the respective measured values to the processor 73. The processor 73 uses the measured current values to produce the first and second control signals 76 and 78.

The first control signal 76 is used to change the output current i_{FC} provided by the fuel cell module 100. If the current demand i_{LOAD} remains elevated after the abrupt change the processor 73 signals the fuel cell module 100 to increase the reaction rate of reactions (1) and (2), thereby causing the fuel cell module 100 to produce more current (i.e. increase i_{FC}). On the other hand, the change in current demand i_{LOAD} may have been negative and the current demand i_{LOAD} may continue to remain lower than before the abrupt change; in which case the processor 73 signals the fuel cell module 100 to decrease the reaction rate of reactions (1) and (2), thereby causing the fuel cell module 100 to produce less current (i.e. decrease i_{FC}). In some embodiments the fuel cell module 100 responds to the first control signal 76 by changing the operation of one or more air blowers to either reduce or increase the flow of oxygen into the cathode of the fuel cell module 100, as determined by the processor 73.

Additionally, in some embodiments the second control signal 78 is used to change the upper-limit current level i′_{FC} enforced by the current limiter. As the output current i_{FC} may be increased, as determined by the processor 73, the upper-limit current level i′_{FC} may also have to be adjusted to allow the increased output current i_{FC} to reach the first electrical node A where (if i_{FC}>i_{LOAD}) the extra current can be diverted to the ultra-capacitor pack 90 and/or the load 115 as required.

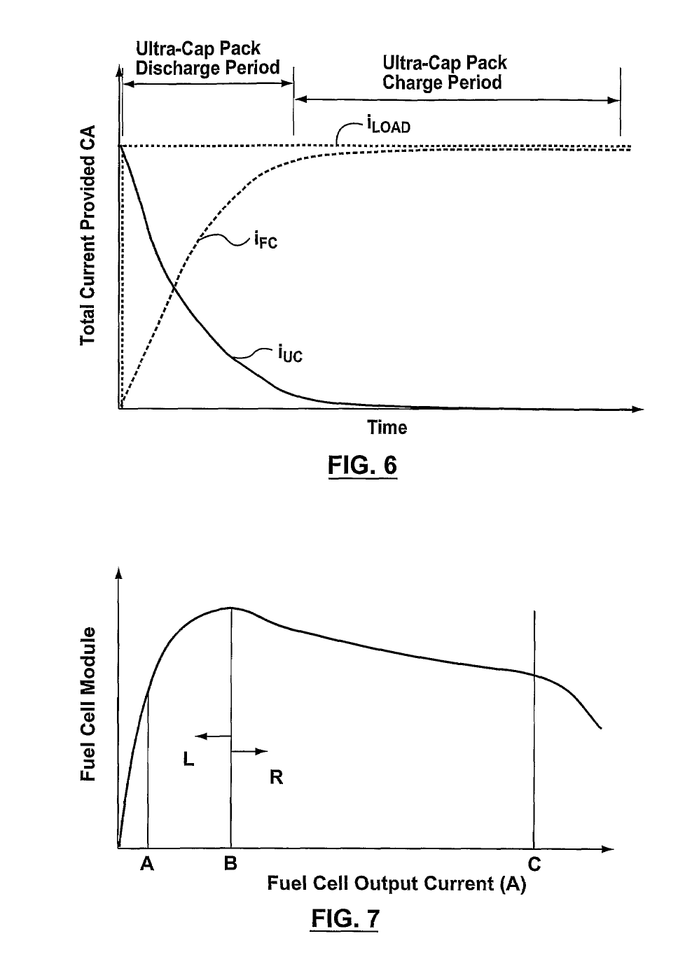

Referring to FIG. 6, with continued reference to FIG. 2, shown is a graphical illustration of an example transient current response of the first fuel cell system, according to an aspect of the invention, to an abrupt change in output current demand i_{LOAD} from the load 115. As noted above, the ultra-capacitor pack 90 is primarily employed to provide an immediate response to abrupt increases in current demand i_{LOAD}. Preferably the total capacitance of the ultra-capacitor pack 90 is provided in sufficient quantity to provide the current burst over a long enough period of time to allow the adaptive current controller 70 in combination with the fuel cell module 100 to controllably raise the output current i_{FC} provided by the fuel cell module 100. That is, a properly sized ultra-capacitor pack 90 provides the time for the fuel cell module 100 in combination with the adaptive current controller 70 to increase reactant flows in order to supply more output current i_{FC} to meet the new elevated current demand i_{LOAD}.

In contrast, if a fuel cell module is used without ultra-capacitors, the fuel cell module must be able to collect information about the current demand i_{LOAD} and try to predict increases in demand before they occur. If the predictions could actually be made the fuel cell module can increase the reactant flow in advance of the increases in demand. As this happens, the fuel cell module generates a feedback signal to indicate how much extra current could be safely drawn. However, there is a delay from increasing the reactant flow to the time when the additional current is available, which means that the overall system is vulnerable to potentially damaging spikes in current demand from the load.

The first fuel cell system including the adaptive current control is not as vulnerable to potentially damaging spikes in current demand i_{LOAD} since the fuel cell module 100 is protected by the current limiter 71 and the ultra-capacitor pack 90 is provided to respond to abrupt changes in current demand i_{LOAD}. Accordingly, the first fuel cell system may be substantially easier to integrate into various applications (e.g. placement into vehicles) as the overall system control does not need to predict changes in current demand i_{LOAD} and/or handle complex data transfer handshaking.

That is, a fuel cell system in accordance with some embodiments of the invention have a relatively low-complexity interface to an application (e.g. for use as a power plant for a vehicle). Unlike other fuel cell systems, which require complex handshaking with the application in order to ensure that reactants flow is adequately adjusted to provide a desired output current without starving the fuel cell module, some fuel cell systems in accordance with some embodiments of the invention do not need a complex system controller. As a result, a fuel cell system, in accordance with some embodiments of the invention, may run close to pure load following conditions.

The adaptive current control 70 is also useful when the first fuel cell system is initially turned on (i.e. powered-up) and when the ultra-capacitor pack 90 needs to be recharged. When the first fuel cell system is not operating to produce power, it is possible that the ultra-capacitor pack 90 is almost completely discharged. Accordingly, when the first fuel cell system is turned-on the variation of voltage (dV/dT) may be quite high, which creates a fairly large current through the ultra-capacitor pack 90. Without current limiting, the amount of current being drawn from the fuel cell module 100 by the ultra-capacitor pack 90 may exceed the capability of the fuel cell module 100 and cause an emergency shutdown to be initiated by a safety control sub-system included in the balance-of-plant system of the fuel cell module 100.

The reason for this is due to the current and voltage characteristics of capacitors, when subjected to a change in voltage, as described by the following equations:

Q=CV (3)

I=C dV/dT (4)

E=_CV² (5)

In the above equations Q represents a capacitor charge (in Coulombs), C is the capacitance (in Farads), V is the voltage (in Volts) across the capacitor, E corresponds to the energy stored in the capacitor and I is the resulting current flowing through the capacitor when its voltage varies over time (dV/dT). Ultra-capacitors used in combination with fuel cell modules are typically sized to provide high current during a transient response. Subsequently, for example, a change of 10 V/s on a 20F ultra-capacitor pack can result in a 200A current draw from the fuel cell module. A typical fuel cell module cannot likely deliver such a large current during a power-up phase of operation, so there is a need to use a current limiting scheme. To address this issue, in some embodiments of the invention the adaptive current controller 70 controllably and progressively increases the voltage across the ultra-capacitor pack 90, thereby limiting the current drawn from the fuel cell module 100. To that end, the processor 73, within the adaptive current controller 70, operates as described above. Once the ultra-capacitor pack 90 is charged, the voltage across the ultra-capacitor pack will normally follow the voltage across the fuel cell module 100 during steady state operation.

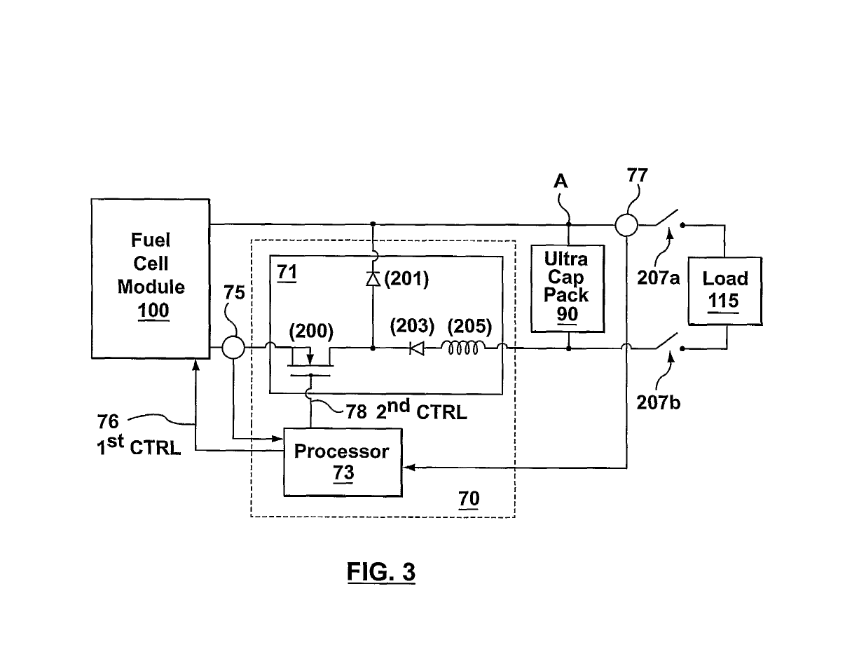

FIG. 3 is a schematic drawing of a second fuel cell system having adaptive current control according to an embodiment of the invention. The second fuel cell system illustrated in FIG. 3 is similar to the first fuel cell system illustrated in FIG. 2, and accordingly, elements common to each are designated using the same reference numerals. For brevity, the description of FIG. 2 will not be repeated with respect to FIG. 3. Moreover, in addition to the features described with reference to FIG. 2, the second fuel cell system illustrated in FIG. 3 includes a very specific arrangement for the current limiter 71 and contactors 207a,b.

The current limiter 71, as illustrated in FIG. 3, includes a current-limiting power transistor 200, which is a very specific example of a current-limiting active device. In various alternative embodiments the current limiting active device includes at least one MOSFET (Metal Oxide Semiconductor Field Effect Transistor), IGBT (Insulated Gate Bipolar Transistor) and/or could be packaged within an integrated unit, such as for example, a DC motor controller. The current-limiting power transistor 200 is controlled by the second control signal 78 provided by the processor 73, as described above.

The current limiter 71 also includes first and second diodes 201 and 203 and an inductor 205. The first diode 201 serves to limit the reverse voltage across the current-limiting power transistor 200. The second diode 203 is placed in series with the inductor 205 between the current-limiting power transistor 200 and an end of the ultra-capacitor pack 90. The second diode 203 is employed to prevent a reverse current to the fuel cell model 100 and the inductor 205 serves to limit the current ripple.

The contactors 207a,b serve to selectively couple and decouple the load 115 from the remainder of the second fuel cell system. In doing so, the contactors 207a,b enable a simple method of avoiding current demand spikes at start-up. During start-up, the contactors 207a,b are opened and the current is limited by carefully adjusting the flow of reactants. When a desired open circuit voltage across the ultra-capacitor pack 90 is reached the contactors 207a,b can be closed coupling the load to the rest of the fuel cell system.

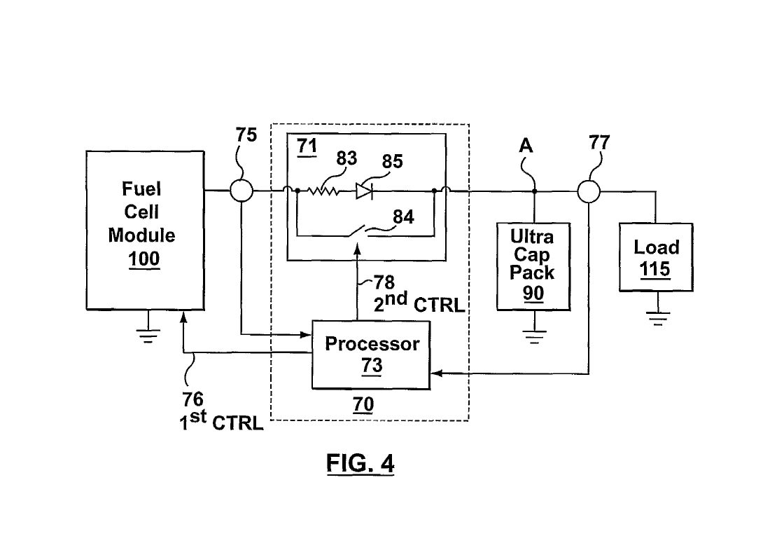

FIG. 4 is a schematic drawing of a third fuel cell system having adaptive current control according to an embodiment of the invention. The third fuel cell system illustrated in FIG. 4 is similar to the first fuel cell system illustrated in FIG. 2, and accordingly, elements common to each are designated using the same reference numerals. For brevity, the description of FIG. 2 will not be repeated with respect to FIG. 4. Moreover, in addition to the features described with reference to FIG. 2, the third fuel cell system illustrated in FIG. 4 includes another very specific arrangement for the current limiter 71.

The current limiter 71, as illustrated in FIG. 4, includes two parallel paths that are selectively used to connect the fuel cell module 100 to the first electrical node A. The first path includes a current-limiting resistor 83 in series with a diode 83. In some embodiments the values of the current-limiting resistor 83 and diode 85 are both fixed. Additionally and/or alternatively, one or both of the current-limiting resistor 83 and diode 85 are adjustable. In such embodiments, the second control signal 78 may also be used to adjust the one or both of the current-limiting resistor and the diode 85. The second path includes a contactor 84 that can be switched between an open and closed state. In some embodiments the second control signal 78 is employed to operate the contactor 84.

During steady state operation the contactor 84 is closed shorting the fuel cell module 100 to the first electrical node A and thereby reducing electrical losses that would otherwise occur through the current-limiting resistor 83 and the diode 85. When the processor 73 detects that the current demand i_{LOAD} has changed (via measurements provided from the current sensing device 77) the processor 73 changes the second control signal 78 to open the contactor 84 re-routing the output current i_{FC} through the current-limiting resistor 83 and the diode 85, and thereby protecting the fuel cell module 100.

Yet another variation of this configuration is possible. Additionally and/or alternatively, a current-limiting active device (e.g. an adjustable diode, transistor, etc.) can be put in the first path with the current-limiting resistor 83 and the diode 85 or in place of the current-limiting resistor 83 and the diode 85.

Shorting the fuel cell module 100 and ultra-capacitor pack 90 together by the use of the contactor 84 limits the overloading benefits by imposing a system voltage range that matches the voltage range of the fuel cell module 100. Since ultra-capacitor voltage is directly linked to the amount of energy that can be stored (see equation above), limiting the voltage range across the ultra-capacitor also limits the peak energy delivery capability, and therefore power delivery capability.

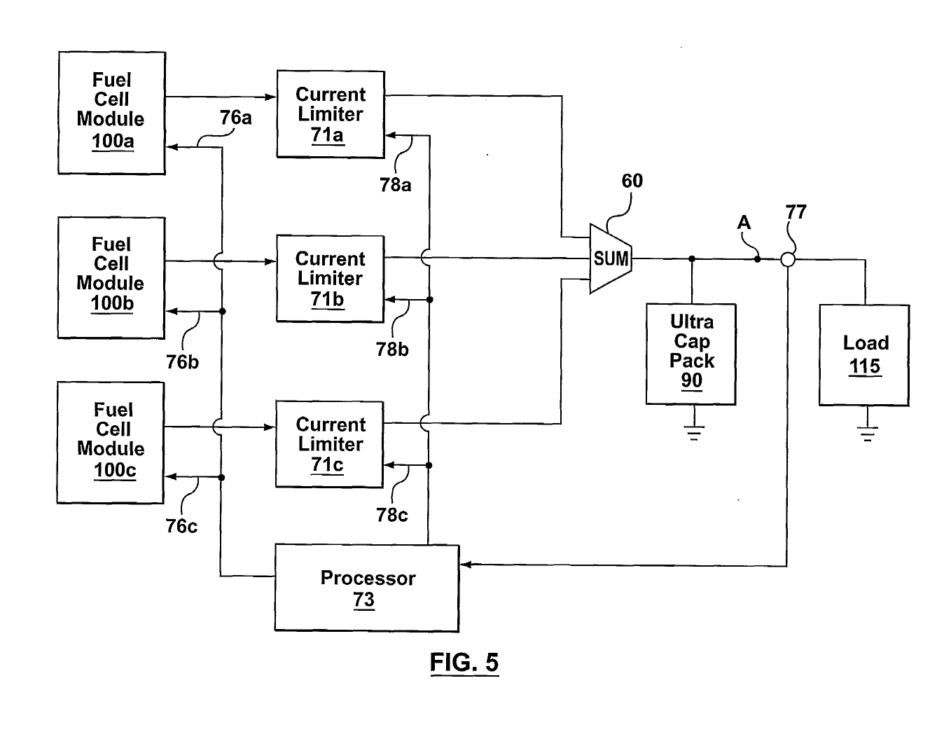

FIG. 5 is a schematic drawing of a fourth fuel cell system having adaptive current control according to an embodiment of the invention. The fourth fuel cell system illustrated in FIG. 5 is an extension of the first fuel cell system illustrated in FIG. 2, and accordingly, elements common to each are designated using the same reference numerals. For brevity, the description of FIG. 2 will not be repeated with respect to FIG. 5.

In addition to the features described with reference to FIG. 2, the fourth fuel cell system illustrated in FIG. 4 includes a number of fuel cell modules 100a, 100b, 100c and a corresponding number of current limiters 71a, 71b, 71c couple the fuel cell modules 100a, 100b, 100c, respectively. The processor 73 provides a set of first control signals 76a, 76b, 76c to the respective fuel cell modules 100a, 100b, 100c, and provides a set of second control signals 78a, 78b, 78c to the respective current limiters 71a, 71b, 71c. As each of the fuel cell modules 100a, 100b, 100c is coupled to respective one of the current limiters 71a, 71b, 71c, the processor can operate each fuel cell module and current limiter pair as described above.

The outputs of the current limiters 71a, 71b, 71c are coupled through a summation node (SUM) 60. In some embodiments the SUM 60 is controlled by the processor 73 to deliver a suitable combination of currents from the fuel cell modules 100a, 100b, 100c to the first electrical node A, which is fixedly or selectively coupled to a load (not shown). In other embodiments the SUM 60 is controlled by a system controller (not shown) or a combination of the system controller and the processor 73.

Additionally, in operation each of the fuel cell modules 100a, 100b, 100c can be operated to provide a different amount of current and/or no current at all. That is, one or more of the fuel cell modules 100a, 100b, 100c may be in an idle mode, serving as a hot standby in the event of a failure of the other fuel cell modules, where process fluids are circulated and humidification and heating/cooling are employed to keep the fuel cell module at working temperature. This type of configuration has benefit in scenarios where power supply cannot be interrupted and/or where the load may demand current that cannot be supplied by one of the fuel cell modules 100a, 100b, 100c alone. This configuration may also be used to provide load balancing, where two or more fuel cell modules are used in parallel in respective peak efficiency modes. Accordingly, of the fuel cell modules 100a, 100b, 100c can be controlled by a master controller (not shown) to efficiently employ reactant supplies for a desired output.

In another mode of operation one, two or all of the fuel cell modules 100a, 100b, 100c can be completely shut down to avoid idling where efficiency is typically lowest. With additional reference to FIG. 7, shown is a graphical illustration of an example of efficiency vs. output current for a fuel cell system according to an aspect of the invention. To improve overall efficiency, one the of the fuel cell modules 100a, 100b, 100c is shut down when its output current falls below a certain threshold A. At this point, that fuel cell module is idling the ultra-capacitor pack 90 and the other fuel cell modules can meet the present current demand i_{LOAD}. When one of the ultra-capacitor pack 90 voltage falls below a low limit threshold and/or the other operating fuel cell modules cannot meet the current demand i_{LOAD}, the off fuel cell module is turned on again, with the corresponding one of the current limiters 71a, 71b, 71c setting the corresponding current upper limit to a value B, which corresponds to the peak efficiency for that fuel cell module. If the current demand i_{LOAD} is lower than B, the excess current is absorbed by the ultra-capacitor pack 90, thereby recharging the ultra-capacitor pack 90. As the ultra-capacitor pack 90 draws less and less current, the output current will decrease until A is reached again and that one of the fuel cell modules 100a, 100b, 100c will again shut off. This scenario corresponds to the left arrow L shown in FIG. 7. On the other hand, if the current demand i_{LOAD} is higher than B, the fuel cell will attempt following the load current up to a third current value C, which represents the output current limit of that one of the fuel cell modules 100a, 100b, 100c. This scenario corresponds to the right arrow R shown in FIG. 7. Care has to be taken in choosing the limits A, B, and C and sizing the ultra-capacitor pack 90 in relation to these limits to ensure that there is a sufficient amount of time to restart the fuel cell module that is turned off.

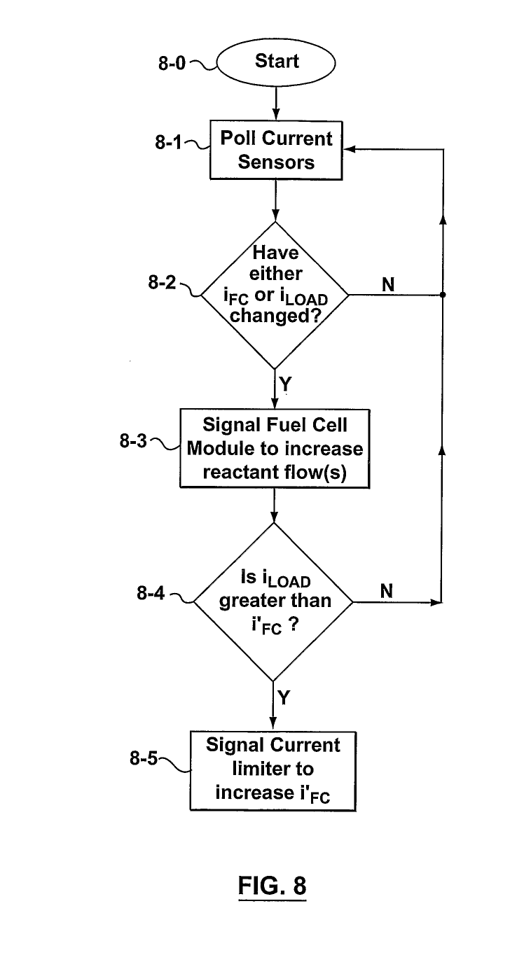

FIG. 8 is a flow chart illustrating a first method of adaptive current control according to an aspect of the invention. Specifically, FIG. 8 shows the some example steps a processor (e.g. processor 73) managing an adaptive current control function for a fuel cell system, according to an aspect of the invention, may follow to control the current drawn (e.g. output current i_{FC}) from a fuel cell module during a transient response to an abrupt change in current demand (e.g. i_{LOAD}).

Starting at step 8-1, the sensing devices measuring the output current i_{FC} (of the fuel cell module) and the current demand i_{LOAD} are polled. At step 8-1, it is determined whether or not the output current i_{FC} or the current demand i_{LOAD} have changed. If neither of the two currents have changed (no path, step 8-2) then step 8-1 is repeated and the sensing devices measuring the output current i_{FC} (of the fuel cell module) and the current demand i_{LOAD} are polled again to receive updated measurements. In some embodiments, there is an enforced delay between polling times. On the other hand, if one of the two currents i_{FC} and i_{LOAD} has changed (yes path, step 8-2), then at step 8-3 the fuel cell module is signaled to increase reactant flow to follow the change detected at step 8-2.

Following step 8-3, it is determined whether or not the current demand i_{LOAD} is greater than the present upper-limit current level i′_{FC} imposed on the fuel cell module by a current limiter. If the current demand i_{LOAD} is not greater than the present upper-limit current level i′_{FC} (no path, step 8-4), then step 8-1 is repeated and the sensing devices measuring the output current i_{FC} (of the fuel cell module) and the current demand i_{LOAD} are polled again to receive updated measurements. On the other hand, if the current demand i_{LOAD} is greater than the present upper-limit current level i′_{FC} (yes path, step 8-4) the current limiter is signaled to increase the value of the upper-limit current level i′_{FC}. In some embodiments the value of the increase is a preset amount, whereas in other embodiments the value of the increase is further determined each time the upper-limit current level i′_{FC} is to be increased. Conversely, the upper-limit current level i′_{FC} may be decreased in response to diminishing current demand i_{LOAD}.

Additionally and/or alternatively, the output current i_{FC} (of the fuel cell module), or voltage, can be managed between respective floor and ceiling values (i.e. lower and upper levels) to further manage the charge stored on an ultra-capacitor pack.

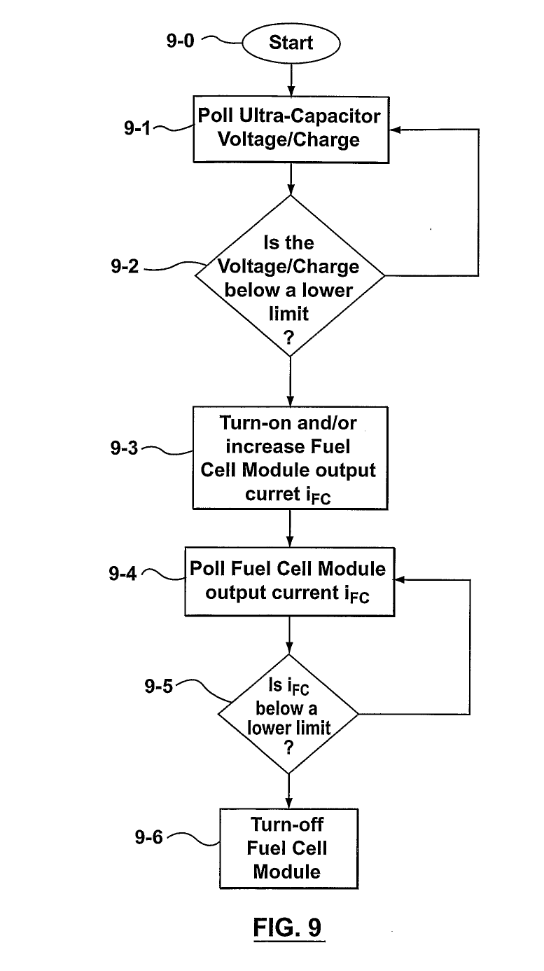

FIG. 9 is a flow chart illustrating a second method of adaptive current control according to an aspect of the invention. Specifically, FIG. 9 shows the some example steps a processor (e.g. processor 73) managing an adaptive current control function for a fuel cell system, according to an aspect of the invention, may follow to reduce idling of a fuel cell module. By managing a fuel cell system in this way, a fuel cell module (included in the system) can be operated more often in a respective peak efficiency range, while the fuel cell module output voltage is maintained within a certain pre-set operating range. Similar to other energy conversion devices, fuel cell modules exhibit a non-linear efficiency vs. power characteristics. Typically, maximum efficiency occurs in the 25-40% total load range. This is because at higher power levels the fuel cell stack typically does not operate as efficiently whereas at lower power levels, the net power output represents less in comparison than the power required to run the supporting systems included in the balance-of-plant system.

Starting at step 9-1, the voltage and/or charge on an ultra-capacitor pack is measured by polling a sensing device connected to measure the voltage and/or charge. At step 9-2, it is determined whether or not the voltage and/or charge is below a lower limit. If the voltage and/or charge is not below the lower limit (no path, step 9-2), then step 9-1 is repeated and the voltage and/or charge is measured again. In some embodiments, there is an enforced delay between polling times. On the other hand, if the voltage and/or charge is below the lower limit (yes path, step 9-2), then at step 9-3 the fuel cell module is signaled to turn on and/or increase reactant flow to recharge the ultra-capacitor pack and/or follow the current demand i_{LOAD} of the load.

Following step 9-3, at step 9-4 the output current i_{FC} of the fuel cell module is monitored by polling a sensing device employed to measure the output current i_{FC}. At step 9-5, it is determined whether or not the output current i_{FC} is below a lower limit (as described above with reference to FIG. 7). If the output current i_{FC} is not below the lower limit (no path, step 9-5), then step 9-4 is repeated to receive an updated measurement of the output current i_{FC}. On the other hand, if the output current i_{FC} is below the lower limit (yes path, step 9-5), then the fuel cell module is signaled to turn-off (i.e. power down) at step 9-6. In some embodiments the lower limit for the output current i_{FC} is set in relation to the foreseen current draw required to recharge the ultra-capacitor pack and the average of the current demand i_{LOAD} by the load expected.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention. Numerous modifications and variations of the present invention are possible in light of the above teachings. It is therefore to be understood that within the scope of the appended claims, the invention may be practiced otherwise than as specifically described herein.

We claim:

1. An adaptive current controller, for use in a fuel cell system including a fuel cell module and an ultra-capacitor, comprising:
a first electrical node connectable to the ultra-capacitor;
a current limiter, connectable between the fuel cell module and the first electrical node, for adjustably limiting the output current of the fuel cell module to an upper-limit current level; and
a processor, connectable to the fuel cell module and the current limiter, having a first input to receive a measurement of the output current of the fuel cell module, a second input to receive a measurement of a current demand, a first output to provide the fuel cell module with a first control signal for changing an operating level of the fuel cell module, and logic for generating the first control signal as a function of the measurements of the output current and current demand.

2. An adaptive current controller according to claim 1, wherein the processor additionally comprises a second output to provide the current limiter a second control signal for changing the upper-limit current level and additional logic for generating the second control signal as a function of the operating level.

3. An adaptive current controller according to claim 1, wherein the logic includes a computer readable program code means embodied thereon for (i) determining if at least one of the output current and the current demand have increased; and (ii) signaling the fuel cell module to change the operating level by increasing reactant flow through the use of the first control signal.

4. An adaptive current controller according to claim 3, wherein the computer readable program code means also includes instructions for (iii) signaling the current limiter to increase the upper-limit current level through the use of the second control signal.

5. An adaptive current controller according to claim 4, wherein the upper-limit current level is signaled to increase if the present upper-limit current level is less than the current demand.

6. An adaptive current controller according to claim 4, wherein the upper-limit current level is signaled to increase as an automatic response to any increase signaled through use of the first control signal.

7. An adaptive current controller according to claim 1, wherein the fuel cell module is a low-pressure fuel cell module employing an air blower to supply oxygen carrying ambient air to the fuel cell module, and wherein the first control signal is employed to change the operation of the air blower to thereby change the amount of oxygen carrying air supplied to the fuel cell module which changes the operating level of the fuel cell module.

8. An adaptive current controller according to claim 1 further comprising a switching device for selectively coupling and decoupling the first electrical node to a load.

9. An adaptive current controller according to claim 8, wherein the processor also has a third output to provide the switching device with a third control signal to selectively couple and decouple the first electrical node to a load.

10. An adaptive current controller according to claim 1, wherein the current limiter includes an active electronic device connectable to the processor for receiving a second control signal for changing the upper-limit current level enforced by the current limiter.

11. An adaptive current controller according to claim 10, wherein the active electronic device is a transistor.

12. An adaptive current controller according to claim 10, wherein the current limiter includes a switching mechanism in parallel with the active electronic device for selectively shorting the fuel cell module to the first electrical node, thereby allowing the output current of the fuel cell module to bypass the active electronic device.

13. An adaptive current controller according to claim 12, wherein the switching mechanism is connectable to the processor for receiving a third control signal for selectively shorting the electrical output of the fuel cell module to the first electrical node.

14. An adaptive current controller according to claim 1, wherein the current limiter includes a series combination of a resistor and a diode connected between the fuel cell module and the first electrical node.

15. An adaptive current controller according to claim 14, wherein the current limiter includes a switching mechanism in parallel with the series combination of the resistor and a diode for selectively shorting the fuel cell module to the first electrical node, thereby allowing the output current of the fuel cell module to bypass the series combination of the resistor and the diode.

16. An adaptive current controller according to claim 15, wherein the switching mechanism is connectable to the processor for receiving a third control signal for selectively shorting the electrical output of the fuel cell module to the first electrical node.

17. An adaptive current controller according to claim 1 further comprising a diode for limiting a potential reverse current to the fuel cell module.

18. An adaptive current controller according to claim 1 further comprising an inductor for limiting ripple current.

19. A fuel cell system comprising:
a fuel cell module;
an ultra-capacitor pack having at least one ultra-capacitor; and
an adaptive current controller having:
a first electrical node connectable to the ultra-capacitor;
a current limiter, coupled between the fuel cell module and the first electrical node, for adjustably limiting the output current of the fuel cell module to an upper-limit current level; and
a processor, coupled to the fuel cell module and the current limiter, having a first input to receive a measurement of the output current of the fuel cell module, a second input to receive a measurement of a current demand, a first output to provide the fuel cell module with a first control signal for changing an operating level of the fuel cell module, and logic for generating the first control signal as a function of the measurements of the output current and current demand.

20. A fuel cell systems according to claim 19, wherein the processor additionally comprises a second output to provide the current limiter a second control signal for changing the upper-limit current level and additional logic for generating the second control signal as a function of the operating level.

21. A fuel cell system according to claim 19, wherein the logic includes a computer readable program code means embodied thereon for (i) determining if at least one of the output current and the current demand have increased; and (ii) signaling the fuel cell module to increase reactant flow through the use of the first control signal.

22. A fuel cell system according to claim 21, wherein the computer readable program code means also includes instructions for (iii) signaling the current limiter to increase the upper-limit current level through the use of the second control signal.

23. A fuel cell system according to claim 22, wherein the upper-limit current level is signaled to increase if the present upper-limit current level is less than the current demand.

24. A fuel cell system according to claim 22, wherein the upper-limit current level is signaled to increase as an automatic response to any increase signaled through use of the first control signal.

25. A fuel cell system according to claim 19, wherein the fuel cell module is a low-pressure fuel cell module employing an air blower to supply oxygen carrying ambient air to the fuel cell module, and wherein the first control signal is employed to change the operation of the air blower to thereby change the amount of oxygen carrying air supplied to the fuel cell module which changes the operating level of the fuel cell module.

26. A fuel cell system according to claim 19 further comprising a switching device for selectively coupling and decoupling the first electrical node to a load.

27. A fuel cell system according to claim 26, wherein the processor also has a third output to provide the switching device with a third control signal to selectively couple and decouple the first electrical node to a load.

28. A fuel cell system according to claim 19, wherein the current limiter includes an active electronic device connectable to the processor for receiving a second control signal for changing the upper-limit current level enforced by the current limiter.

29. A fuel cell system according to claim 28, wherein the active electronic device is a transistor.

30. A fuel cell system according to claim 28, wherein the current limiter includes a switching mechanism in parallel with the active electronic device for selectively shorting the fuel cell module to the first electrical node, thereby allowing the output current of the fuel cell module to bypass the active electronic device.

31. A fuel cell system according to claim 30, wherein the switching mechanism is connectable to the processor for receiving a third control signal for selectively shorting the electrical output of the fuel cell module to the first electrical node.

32. A fuel cell system according to 19, wherein the current limiter includes a series combination of a resistor and a diode connected between the fuel cell module and the first electrical node.

33. A fuel cell system according to claim 32, wherein the current limiter includes a switching mechanism in parallel with the series combination of the resistor and a diode for selectively shorting the fuel cell module to the first electrical node, thereby allowing the output current of the fuel cell module to bypass the series combination of the resistor and the diode.

34. A fuel cell system according to claim 33, wherein the switching mechanism is connectable to the processor for receiving a third control signal for selectively shorting the electrical output of the fuel cell module to the first electrical node.

35. A fuel cell system according to claim 19 further comprising a diode for limiting a potential reverse current to the fuel cell module.

36. A fuel cell system according to claim 19 further comprising an inductor for limiting ripple current.

37. A method of operating a fuel cell system, the fuel cell system including a fuel cell module and an ultra-capacitor, the method comprising:
measuring the output current of the fuel cell module and current demand;
determining if at least one of the output current and current demand have changed; and
signaling the fuel cell module to change the reactant flow in response to a change in either of the output current and current demand.

38. A method according to claim 37 further comprising:
determining if the current demand is greater than an upper-limit current level enforced on the fuel cell module; and
increasing the upper-limit current level if the current demand is greater than the upper-limit current level.

39. A method according to claim 37, wherein if at least one of the output current and current demand have increased, the fuel cell module is signaled to increase reactant flow.

40. A method according to claim 37, wherein if both the output current and current demand have decreased, the fuel cell module is signaled to decrease reactant flow.

41. A method of operating a fuel cell system, the fuel cell system including a fuel cell module and an ultra-capacitor, the method comprising:
monitoring at least one of the voltage and charge on the ultra-capacitor;
determining if the monitored at least one of the voltage and charge is below a first lower limit;
one of turning-on and increasing the output current of the fuel cell module if the monitored at least one of the voltage and charge is below the first lower limit;
monitoring the output current of the fuel cell module;
determining if the output current is below a second lower limit; and
turning-off the fuel cell module if the output current is below the second lower limit.
